(19) United States
(12) Patent Application Publication
(10) Pub. No.: US 2024/0122167 A1
(43) Pub. Date: Apr. 18, 2024

(54) Fishing Weight Attachment Device

(71) Applicant: Ross William Bain, North Ipswich (AU)

(72) Inventor: Ross William Bain, North Ipswich (AU)

(21) Appl. No.: 17/967,120

(22) Filed: Oct. 17, 2022

(51) Int. Cl. A01K 91/04; A01K 95/00

(52) U.S. Cl. CPC A01K 91/04; A01K 95/00

(57) ABSTRACT

A fishing weight attachment device is formed by a wire frame and includes a mounting coil and a locking element. The mounting coil is formed of a plurality of spaced loops. The locking element is formed by a pair of loops in the wire frame, wherein the fishing line may be frictionally engaged between the pair of loops so that the wire frame does not slide along the fishing line. A pliable sleeve is positioned around the wire frame extending over the pair of loops of the wire frame, such that the fishing line may be frictionally engaged between the pair of loops so that the wire frame does not slide along the fishing line, and such that the pliable sleeve protects the fishing line from being damaged by being pinched by the pair of loops.

### BACKGROUND OF THE INVENTION

### Field of the Invention

This invention relates generally to fishing devices, and more particularly to a fishing weight attachment device.

### Description of Related Art

The prior art teaches various weight attachment devices for attaching a fishing weight to a fishing line. For example, Smith, U.S. Pat. No. 2,217,972, teaches a slip sinker that includes a wire frame with line guides at either end for receiving the fishing line. A tight coiled line clamp is provided for pinching the fishing line for preventing movement of the slip sinker with respect to the fishing line.

The problem with this construction is that the tight coiled line clamp tends to crimp and otherwise damage the fishing line, so that it breaks under strain. This long-known problem has rendered this arrangement relatively useless, and thus this type of slip sinker has not generally been used.

### SUMMARY OF THE INVENTION

The present invention teaches certain benefits in construction and use which give rise to the objectives described below.

The present invention provides a fishing weight attachment device adapted to receive a fishing weight and attach to a fishing line. The fishing weight attachment device includes a wire frame and a mounting coil formed in the wire frame that enables the device to attach to the fishing line by positioning the fishing line therethrough. A pair of loops in the wire frame are positioned adjacent the mounting coil, and a pliable sleeve is positioned around the wire frame extending over the pair of loops of the wire frame, wherein the fishing line may be frictionally engaged between the pair of loops so that the wire frame does not slide along the fishing line, and wherein the pliable sleeve protects the fishing line from being damaged by being pinched by the pair of loops. The wire frame further includes a first elongate portion shaped to extend through a bore of the fishing weight, and a second elongate portion, and a releasable closure that removably engages the first elongate portion with the second elongate portion for securing the fishing weight on the wire frame.

A primary objective of the present invention is to provide a fishing weight attachment device that is able to clamp the fishing line in a manner similar to Smith, as discussed above, but includes a protective pliable sleeve that prevents the device from damaging the fishing line while in use.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a fishing weight attachment device according to one embodiment of the present invention and showing a first fishing weight;

FIG. 2 is a perspective view thereof, showing the fishing weight attachment device mounted on a fishing line, with a plurality of fishing weights mounted upon the fishing weight attachment device;

FIG. 3 is a perspective view of a second embodiment of the fishing weight attachment device with the first fishing weight mounted thereupon; and

FIG. 4 is a side elevation view of the fishing weight attachment device of FIG. 2, illustrating portions of the device broken away to better illustrate the device.

### DETAILED DESCRIPTION OF THE INVENTION

The above-described drawing figures illustrate the invention, a fishing weight attachment device adapted to receive a fishing weight and attach to a fishing line.

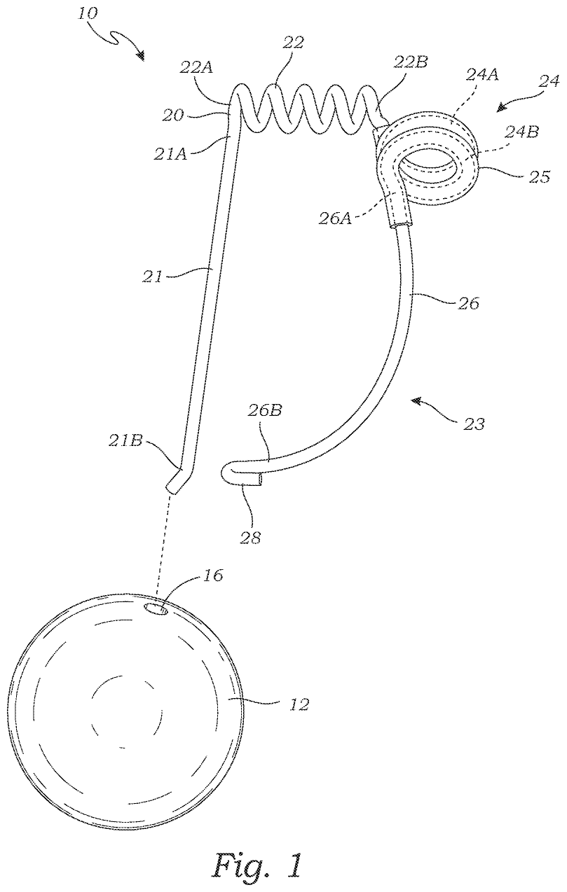

FIG. 1 is a perspective view of a fishing weight attachment device 10 according to one embodiment of the present invention. As shown in FIG. 1, the fishing weight attachment device 10 comprises a wire frame 20. In some embodiments, the wire frame 20 may be constructed of a single piece of wire that is resilient and non-corrosive for use in water (commonly salt water), and which may be tempered to allow at least some bending and spring. In other embodiments, however, it may be formed of two parts that are engaged with each other in a manner known in the art. The wire frame 20 may be of any suitable material, but in the present embodiment it is a resilient material such as spring steel, or a suitable plastic. The wire frame 20 may be bent to form the operative structures described in greater detail below. In another embodiment, however, it may be constructed using a different structure, and/or may include additional elements mounted on the wire frame.

As shown in FIG. 1, the wire frame 20 includes a mounting coil 22, a locking element 24, and a means for mounting 23 at least one fishing weight 12, each component being discussed at length below.

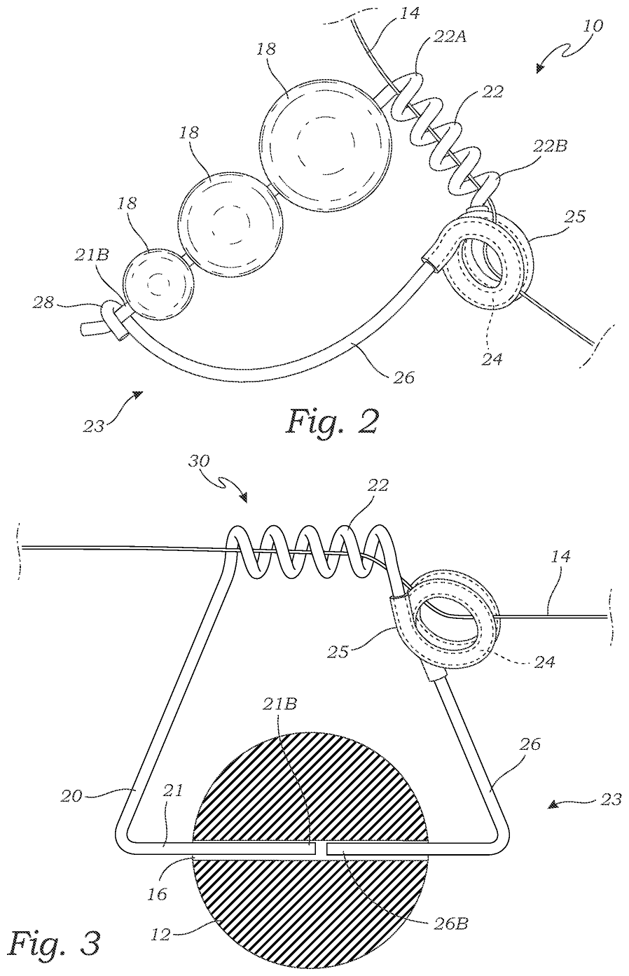

As shown in FIG. 1, in this embodiment, the mounting coil 22 is in the form of a plurality of spaced loops, which may be evenly spaced, formed in the wire frame 20. In this embodiment, the mounting coil 22 is in the form of a helix which defines an axis A, and extends from a first end 22A and a second end 22B. The fishing line 14 (shown in FIG. 2) is positioned through the coils 22, along the axis A, so that the device 10 is slidably mounted on the fishing line.

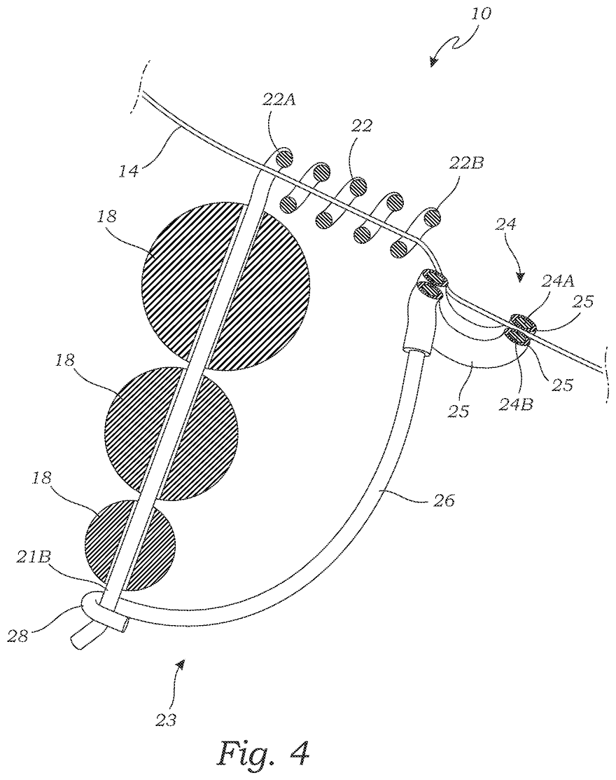

FIG. 2 is a perspective view of the fishing weight attachment device 10 operably mounted on a fishing line 14. FIG. 4 is a side elevation view of the fishing weight attachment device 10 of FIG. 2, illustrating portions of the device 10 broken away to better illustrate the device 10. As shown in FIGS. 1, 2, and 4, the locking element 24 is adapted for removably locking with fishing line being used in conjunction with the device 10. In this embodiment, the locking element 24 is formed in the wire frame 20 adjacent the second end 22B of the mounting coil 22 and is in the form of a pair of loops 24A and 24B in the wire frame (although a greater number of loops may be used). The pair of loops 24 are slightly spaced to enable the provision of a pliable sleeve 25 that is positioned around the wire frame 20 extending over the pair of loops 24, such that the fishing line may be frictionally engaged between the pair of loops 24 so that the wire frame 20 does not slide along the fishing line, and such that the pliable sleeve 25 protects the fishing line from being damaged by being pinched by the pair of loops 24. As shown in FIGS. 1 and 4, the fishing line may thus be frictionally engaged between the loops 24 (24A and 24B), and the protective pliable sleeve 25 will protect the fishing line from being crimped or otherwise damaged by the hard wire of the pair of loops 24. In the current embodiment, the pliable sleeve 25 is an extruded silicone tube or sleeve with a 1.5 mm hole through the center. However, in alternative constructions, the pair of loops 24 and/or the pliable sleeve 25 may have alternative configurations (the pliable sleeve may be, for example, made of plastic or any other pliable material that can provide the necessary protection), and alternative shapes, so long as they are configured to function as described herein.

In this embodiment, the locking element 24 is positioned adjacent and beneath the axis A of the mounting coil 22. In this manner, the fishing line 14 (shown in FIG. 2) may be pulled downward (relative to the axis A) and frictionally locked in the locking element 24, and when a fish pulls on the line, the tension pulls the line out of the locking element 24 and allows the device 10 to slide freely on the fishing line.

As illustrated, the fishing weight attachment device 10 further includes the means for removably mounting 23 the at least one fishing weight 12 on the fishing weight attachment device 10. In this embodiment, the means 23 comprises a first elongate portion 21 extending from the first end 22A of the mounting coil 22, and a second elongate portion 26 that extends from the locking element 24 to a releasable closure 28 that removably engages the first elongate portion 21, each component being discussed below.

In some embodiments, the first elongate portion 21 has a proximal end 21a that extends from the first end 22a of the mounting coil 22 to a distal end 21b mounting coil 22. In this embodiment, the first elongate portion 21 extends from the coil 22 approximately perpendicular to the axis A of the coil 22. In the embodiment of FIG. 1, the first elongate portion 21 is sized and shaped to extend through a bore 16 of the fishing weight 12, wherein the first elongate portion 21 has a diameter that is smaller than the diameter of the bore 16 of the fishing weight 12. In various implementations of the present invention, the fishing weight 12 may be in the form of a standard single annular weight, but in other embodiments may be another type of weight, as shown in FIG. 2 and discussed below.

In this embodiment, the second elongate portion 26 has a proximal end 26a that extends from the locking element 24 and curves to the releasable closure 28 at a distal end 26b for removable attachment to the first elongate portion 21. However, the second elongate portion 26 may instead include an angle or angles (as shown in FIG. 3), or be generally straight, depending on the structure of the rest of the components. In this embodiment, the releasable closure 28 is in the form of a “C” catch for receiving the first elongate portion 21, but in other embodiments may be any other similar type of closure, e.g., a safety catch, clasp, etc.

FIG. 2 further showing a plurality of fishing weights 18 mounted on the first elongate portion 21. As shown in FIG. 2, in this embodiment, the fishing weights 18 are in the form of a three differently sized annular weights. However, various sizes, both in diameter and in width of the annular weights 18, may be used to provide a variable amount of weight for the device 10. Further, the weights 18 may be another shape, i.e., rectangular, irregular, etc., as is well-known in the art. The weights 12 and 18 may, likewise, be plated to form a fish-attracting feature, or include any other features commonly associated with this type of product.

As shown in FIG. 2, in use, the releasable closure 28 of the attachment device 10 is first opened such that the first elongate portion 21 may pass through the bores 16 of the fishing weights 18 to mount the weights 18 on the device 10, and then the releasable closure 28 is closed to secure the fishing weights 18. In this embodiment, the first elongate portion 21 may be generally straight to allow for a larger fishing weight 12, or plurality of fishing weights 18. In other embodiments, the first elongate portion 21 may be slightly curved or include at least one angle, depending on the needs of the manufacturer.

Once the weights 18 have been mounted on the first elongate portion 21, the fishing line 14 may be mounted on the mounting coil 22 by winding the fishing line 14 through the spaces between the loops of the coil 22 until the line 14 extends through the coil 22, without having to cut the fishing line 14 from a rod (not shown) and thread it through the device 10. Once mounted on the mounting coil 22, the user positions the device 10 in a desired location on the fishing line 14, wherein the fishing line 14 may be locked in place with the locking element 24 by sliding the fishing line 14 between the loops 24 in the wire, such that the device 10 does not slide along the fishing line 14.

If desired, the device 10 may also be attached to a float (not shown) to fish on the water's surface. The float may then be easily removed and replaced with the fishing weight(s) 12 or 18 to fish beneath the water, without having to cut the fishing line 14 or remove the device 10 from the fishing line 14. When a fish bites the bait/hook, the tension applied to the fishing line 14 may allow the fishing line 14 to jump out of the locking element 24, which causes the fishing weight attachment device 10 to slide freely down the fishing line 14 toward the hook, so that the device 10 does not cause unwanted counterbalance while reeling in the fish.

FIG. 3 is a perspective view of a second embodiment 30 of the fishing weight attachment device, showing an alternative means for removably mounting 32 the first fishing weight 12. In the embodiment of FIG. 3, the means for removably mounting 32 includes a first elongate portion 34 and a second elongate portion 36, which together capture the weight(s) 18 therebetween. In this embodiment, the first elongate portion 34 extends from a proximal end 34a from the mounting coil 22 and angles toward the second elongate portion 36 to a distal end 34b. The second elongate portion 36 extends from a proximal end 36a from the locking element 24 and angles toward the first elongate portion 34 to a distal end 36b. In use, the flexible wire may be manipulated to allow the fishing weight 12 to be mounted on the device 30 such that the distal ends 34b and 36b of the two portions 34 and 36 together capture the fishing weight 12.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced items unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A fishing weight attachment device adapted to receive at least one fishing weight and attach to a fishing line, the fishing weight attachment device comprising:
a wire frame;
a mounting coil formed in the wire frame that enables the device to attach to the fishing line by positioning the fishing line through the mounting coil;
a pair of loops in the wire frame adjacent the mounting coil;
a pliable sleeve positioned around the wire frame extending over the pair of loops of the wire frame, wherein the fishing line may be frictionally engaged between the pair of loops so that the wire frame does not slide along the fishing line, and wherein the pliable sleeve protects the fishing line from being damaged by being pinched by the pair of loops; and
a means for removably mounting the at least one fishing weight on the wire frame.

2. The fishing weight attachment device of claim 1, wherein the mounting coil is in the form of a plurality of spaced loops.

3. The fishing weight attachment device of claim 1, wherein the means for removably mounting comprises a first elongate portion shaped to extend through a bore of the fishing weight, and a second elongate portion that extends to a releasable closure that removably engages the first elongate portion.

4. The fishing weight attachment device of claim 1, wherein the mounting coil is in the form of a helix which defines an axis about which a plurality of spaced loops are disposed, and the plurality of spaced loops are equally spaced from each other.

5. The fishing weight attachment device of claim 4, wherein the locking element is positioned adjacent the mounting coil and beneath the axis of the mounting coil.

6. A fishing weight attachment device adapted to receive at least one fishing weight and attach to a fishing line, the fishing weight attachment device comprising:
a wire frame;
a mounting coil formed in the wire frame that enables the device to attach to the fishing line by positioning the fishing line through the mounting coil;
a pair of loops in the wire frame adjacent the mounting coil;
a pliable sleeve positioned around the wire frame extending over the pair of loops of the wire frame, wherein the fishing line may be frictionally engaged between the pair of loops so that the wire frame does not slide along the fishing line, and wherein the pliable sleeve protects the fishing line from being damaged by being pinched by the pair of loops;
a first elongate portion of the wire frame shaped to extend through a bore of the fishing weight, and a second elongate portion of the wire frame; and
a releasable closure that removably engages the first elongate portion with the second elongate portion for securing the fishing weight on the wire frame.
